(19) United States
(12) Patent Application Publication
(10) Pub. No.: US 2014/0065906 A1
(43) Pub. Date: Mar. 6, 2014

(54) SUPER HYDROPHOBIC MEMBRANE AND METHOD OF MANUFACTURING THE SAME

(71) Applicant: SAMSUNG ELECTRO-MECHANICS CO., LTD., Gyunggi-do (KR)

(72) Inventors: Sun Ok Kim, Gyunggi-do (KR); Jin Wook Na, Gyunggi-do (KR); Kwon Min Jeon, Gyunggi-do (KR); Jae Sik Ryoo, Gyunggi-do (KR)

(73) Assignee: Samsung Electro-Mechanics Co., LTD., Gyunggi-do (KR)

(21) Appl. No.: 13/708,357

(22) Filed: Dec. 7, 2012

(30) Foreign Application Priority Data
Sep. 5, 2012 (KR) 10-2012-0098442

(51) Int. Cl. B32B 27/18

(52) U.S. Cl. CPC B32B 27/18
USPC 442/82; 264/466; 427/569

(57) ABSTRACT

There are provided a super hydrophobic membrane and a method of manufacturing the same, the super hydrophobic membrane including a base layer containing a base polymer and a water-repellent additive containing fluorine, and having a nano-fiber structure. The super hydrophobic membrane capable of having water-repellency even with respect to liquid such as a surfactant, having relatively low surface energy, may be implemented.

### CROSS-REFERENCE TO RELATED APPLICATIONS

This application claims the priority of Korean Patent Application No. 10-2012-0098442 filed on Sep. 5, 2012, in the Korean Intellectual Property Office, the disclosure of which is incorporated herein by reference.

### BACKGROUND OF THE INVENTION

1. Field of the Invention

The present invention relates to a super hydrophobic membrane capable of selectively repelling water and being adhered by an electro-spinning method, and a method of manufacturing the same.

2. Description of the Related Art

A general membrane basically has air-permeability and may have water-repellency according to material properties thereof.

The membrane may be generally formed by an electro-spinning method, wherein the electro-spinning method is a method of instantly spinning a low-viscous polymer into fibers using electrostatic force to obtain a fiber product.

The electro-spinning method has an important feature in that nanometer scale fibers may be manufactured thereby using a material having a micro-diameter.

When the electro-spinning method is used, micro-fibers may be produced, and when the micro-fibers are produced, a web may be obtained therefrom.

In the electro-spinning method, a liquid polymer solution obtained by dissolving polymers in a solvent is used, where hydrophobic properties or hydrophilic properties may be implemented according to the type of polymers used therein.

The hydrophobic properties or hydrophilic properties may be easily implemented with respect to general water (H₂O).

However, it is difficult to implement the hydrophobic properties with respect to liquid containing a material such as a surfactant, reducing surface energy thereof, due to a porous structure peculiar to the membrane.

Therefore, development of a super hydrophobic membrane having hydrophobic properties implemented therein, even with respect to the liquid containing a material such as a surfactant, reducing surface energy thereof, has been demanded.

Meanwhile, the membrane may be used to form a channel in a biochip, or the like, and in order to implement a completed device including this channel formed therein, the hydrophobic membrane should be easily adhered to another material.

However, in the case of a general hydrophobic membrane, adhesion performance with regard to another material may be reduced.

The following related art document discloses a western blotting membrane containing polyvinylidene fluoride (PVDF); however, the western blotting membrane does not show super hydrophobic properties.

### RELATED ART DOCUMENT

Korean Patent Laid-Open Publication No. 2012-0021734

### SUMMARY OF THE INVENTION

An aspect of the present invention provides a super hydrophobic membrane capable of selectively repelling water and being adhered by an electro-spinning method, and a method of manufacturing the same.

According to an aspect of the present invention, there is provided a super hydrophobic membrane including a base layer containing a base polymer and a water-repellent additive containing fluorine, and having a nano-fiber structure.

The base polymer may be hydrophobic or hydrophilic.

The base polymer may be polyvinylidene fluoride (PVDF).

The water-repellent additive may be a polymeric material.

The water-repellent additive may be at least one selected from a group consisting of poly(2,2,2-trifluoroethyl 2-fluoroacrylate), poly(1-acetyl-1-fluoroethylene), and poly(2,2,3,3,4,4,5,5-octafluoropentyl 2-fluoroacrylate).

The water-repellent additive may be a urethane-based material, a monomer or an oligomer.

A surface of the base layer having the nano-fiber structure may be hydrophilic treated or provided with a hydrophilic material layer containing a hydrophilic material.

A surface of the base layer having the nano-fiber structure may have a contact angle of 120° or more.

According to another aspect of the present invention, there is provided a method of manufacturing a super hydrophobic membrane including: preparing a mixture solution by adding a water-repellent additive containing fluorine to a polymer solution obtained by dissolving a base polymer in a solvent; and forming a base layer having a nano-fiber structure by spinning the mixture solution in an electro-spinning method.

The base polymer may be hydrophobic or hydrophilic.

The base polymer may be polyvinylidene fluoride (PVDF).

The water-repellent additive may be a polymeric material.

The water-repellent additive may be at least one selected from a group consisting of poly(2,2,2-trifluoroethyl 2-fluoroacrylate), poly(1-acetyl-1-fluoroethylene), and poly(2,2,3,3,4,4,5,5-octafluoropentyl 2-fluoroacrylate).

The water-repellent additive may be a urethane-based material, a monomer or an oligomer.

The method of manufacturing a super hydrophobic membrane may further include performing a hydrophilic treatment on a surface of the base layer having the nano-fiber structure, and the hydrophilic treatment may be performed by a plasma method or a coating method.

The method of manufacturing a super hydrophobic membrane may further include forming a hydrophilic material layer containing a hydrophilic material on a surface of the base layer having the nano-fiber structure by the electro-spinning method.

A surface of the base layer having the nano-fiber structure may have a contact angle of 120° or more.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view schematically showing a super hydrophobic membrane according to an embodiment of the present invention;

FIG. 2 is a schematic view showing an electro-spinning device used to manufacture the super hydrophobic membrane according to the embodiment of the present invention;

FIG. 3 is a microscope photograph of the super hydrophobic membrane according to the embodiment of the present invention;

FIGS. 4A and 4B are photographs comparing water-repellencies of membranes in the case of adding a water-repellent additive and in the case of not adding the water-repellent additive, respectively; and

FIGS. 5A and 5B are photographs comparing contact angles of membranes in the case of adding a water-repellent additive and in the case of not adding the water-repellent additive, respectively.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

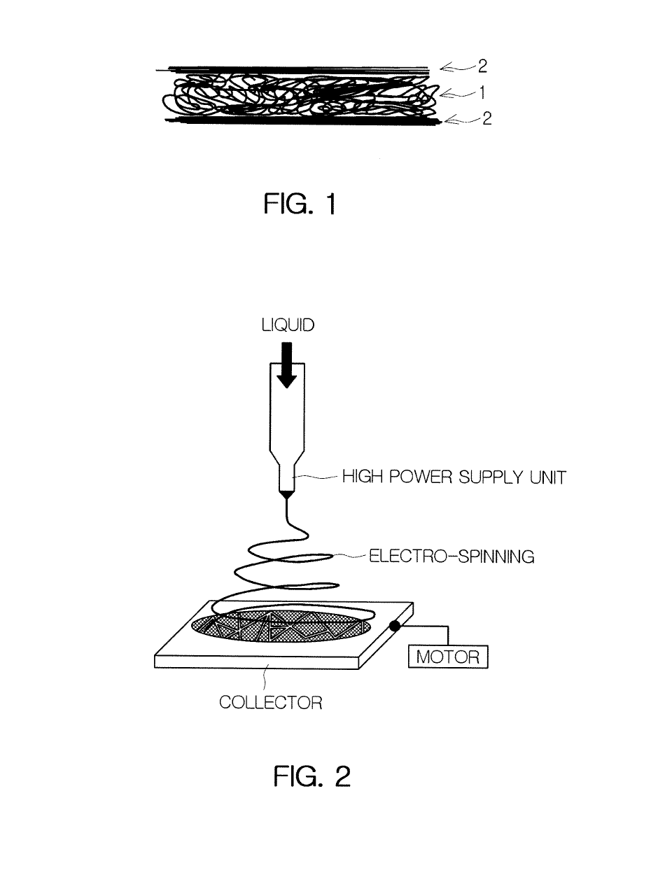

FIG. 1 is a view schematically showing a super hydrophobic membrane according to an embodiment of the present invention.

Referring to FIG. 1, the super hydrophobic membrane according to the embodiment of the present invention may include a base layer 1 containing a base polymer and a water-repellent additive containing fluorine, and having a nano-fiber structure.

The base polymer is not particularly limited but may be, for example, hydrophobic or hydrophilic.

Particularly, in the case in which the base polymer is a hydrophobic material, the base polymer may be polyvinylidene fluoride (PVDF).

The following Chemical Formula 1 shows a structure of polyvinylidene fluoride (PVDF).

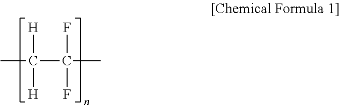

Generally, in the case in which the base polymer is a hydrophobic material such as polyvinylidene fluoride (PVDF), a membrane formed of the base polymer may easily have hydrophobic properties with respect to water (H₂O).

However, it may be difficult to provide the hydrophobic properties with respect to liquid containing a material such as a surfactant, reducing surface energy, due to a porous structure peculiar to the membrane.

Meanwhile, as another method, a hydrophobic membrane may be manufactured by a coating and precipitating method after forming micro-fibers using hydrophilic polymers, or the like.

Even in the case in which the membrane is manufactured by the above-mentioned method, it may be difficult to provide the membrane with hydrophobic properties with respect to a liquid having a surface energy lower than that of water, and a web having one property is manufactured using one material. Therefore, it may be difficult to have various properties in a complicated structure such as a biochip, or the like.

However, according to the embodiment of the present invention, the base layer 1 having a nano-fiber structure further contains the water-repellent additive containing fluorine in addition to the base polymer, such that hydrophobic properties may be implemented even with respect to the liquid containing a material such as a surfactant, reducing surface energy.

Any water-repellent additive containing fluorine may be used as long as the additive may be additionally added to the base polymer so as to have the hydrophobic properties with respect to the liquid having relatively low surface energy.

For example, the water-repellent additive may be a polymeric material, a monomer or an oligomer.

In the case in which the water-repellent additive is a polymeric material, the material may be at least one selected from a group consisting of poly(2,2,2-trifluoroethyl 2-fluoroacrylate), poly(1-acetyl-1-fluoroethylene), and poly(2,2,3,3,4,4,5,5-octafluoropentyl 2-fluoroacrylate), but is not limited thereto.

The following Chemical Formulas 2 through 4 indicate structures of poly(2,2,2-trifluoroethyl 2-fluoroacrylate), poly(1-acetyl-1-fluoroethylene), and poly(2,2,3,3,4,4,5,5-octafluoropentyl 2-fluoroacrylate), respectively.

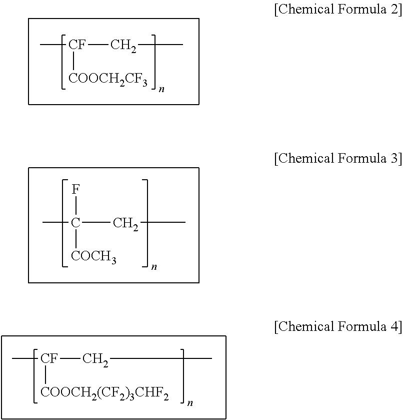

Meanwhile, the water-repellent additive may be a urethane-based material containing fluorine, a monomer or an oligomer.

The following Chemical Formulas 5 through 7 indicate structures of examples of the water-repellent additive that are not polymeric materials.

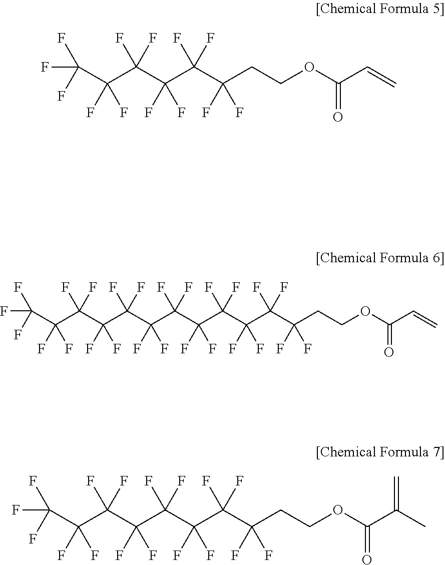 [SMILES: C=CC(=O)OCCC(F)(F)C(F)(F)C(F)(F)C(F)(F)C(F)(F)C(F)(F)F ; C=CC(=O)OCCC(F)(F)C(F)(F)C(F)(F)C(F)(F)C(F)(F)C(F)(F)C(F)(F)C(F)(F)C(F)(F)C(F)(F)C(F)(F)C(F)(F)F ; C=C(C)C(=O)OCCC(F)(F)C(F)(F)C(F)(F)C(F)(F)C(F)(F)C(F)(F)C(F)(F)C(F)(F)F]

The base layer 1 having the nano-fiber structure further contains the water-repellent additive containing fluorine in addition to the base polymer, such that hydrophobic properties may be implemented even with respect to the liquid containing a material such as a surfactant, reducing surface energy.

A method of forming the base layer 1 having the nano-fiber structure is not particularly limited, but may be performed, for example, by an electro-spinning method.

FIG. 2 is a schematic view showing an electro-spinning device used to manufacture the super hydrophobic membrane according to the embodiment of the present invention.

A detailed description of the method of forming the base layer 1 having the nano-fiber structure will be provided in a method of manufacturing a super hydrophobic membrane to be described below.

Meanwhile, according to the embodiment of the present invention, hydrophilic treatment may be performed on a surface of the base layer 1 having the nano-fiber structure, or a hydrophilic material layer 2 containing a hydrophilic material may be formed on the surface of the base layer 1 having the nano-fiber structure.

Generally, an air-permeable membrane having hydrophobic properties may be used in micro-electro-mechanical systems (MEMS), biochips, or the like, but it may be problematic in terms of adhesion with regard to different materials.

However, in the super hydrophobic membrane according to the embodiment of the present invention, the hydrophilic treatment is performed on a surface of the base layer 1 having the nano-fiber structure, or a hydrophilic material layer 2 containing a hydrophilic material is formed on the surface, as describe above, such that the membrane may be easily adhered to different materials.

Therefore, the super hydrophobic membrane according to the embodiment of the present invention may be used in micro-electro-mechanical systems (MEMS), biochips, or the like.

A method of performing a hydrophilic treatment on the surface of the base layer 1 having the nano-fiber structure is not particularly limited. For example, a plasma method, a hydrophilic coating method, or the like, may be used.

In addition, a method of forming the hydrophilic material layer 2 containing a hydrophilic material on the surface of the base layer 1 having the nano-fiber structure is not particularly limited. For example, the hydrophilic material layer 2 may be formed by electro-spinning a hydrophilic material.

The hydrophilic material layer 2 may only be formed on one surface of the base layer 1 having the nano-fiber structure or may be formed on both surfaces thereof. In the case in which the hydrophilic material layer 2 is formed on both surfaces, the membrane may have a multi-layer structure in which hydrophilic-hydrophobic-hydrophilic layers are sequentially multilayered, such that adhesion with regard to different materials may be further improved.

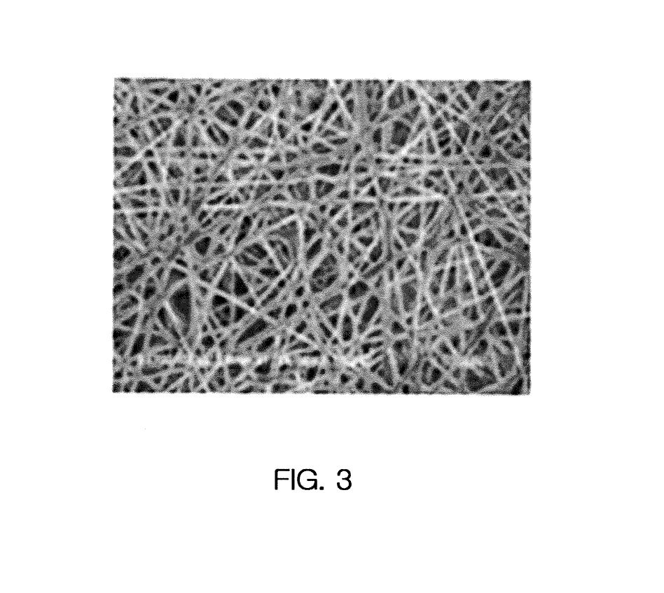

FIG. 3 is a microscope photograph of the super hydrophobic membrane according to the embodiment of the present invention.

Referring to FIG. 3, the super hydrophobic membrane according to the embodiment of the present invention may have the nano-fiber structure and may also have air-permeability, and a pore size thereof may be also adjusted in order to adjust the air-permeability.

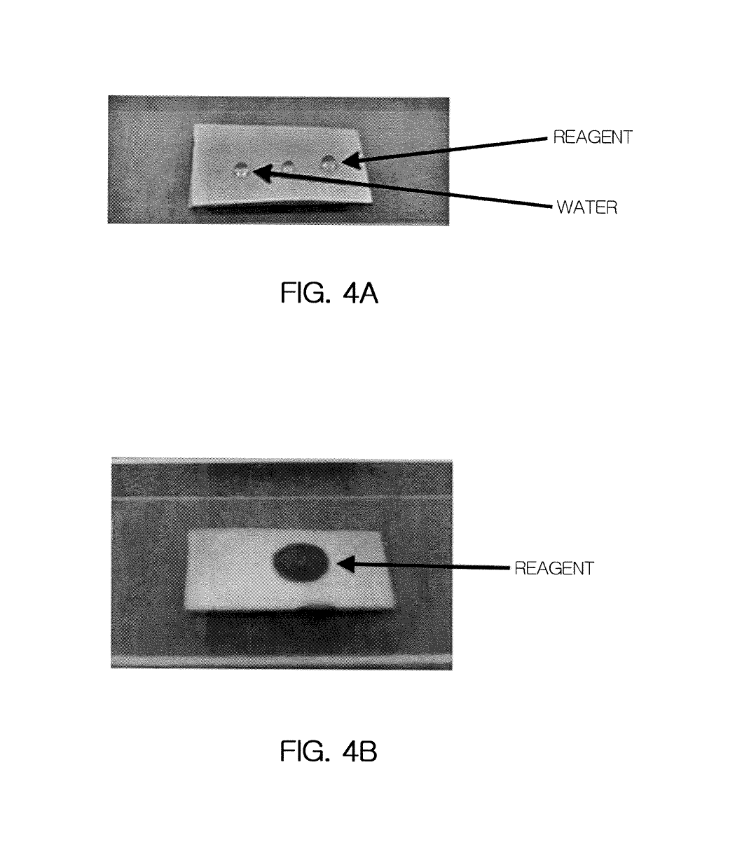

FIGS. 4A and 4B are photographs comparing water-repellencies of membranes in the case of addition of a water-repellent additive and in the case of non-addition of a water-repellent additive, respectively.

In the case of a membrane in which a water-repellent additive is added, it may be appreciated that when water (H₂O) and a reagent having surface energy corresponding to ⅓ of that of water (H₂O) are dropped, the membrane has hydrophobic properties (please see FIG. 4A).

On the other hand, in the case of a membrane formed only of polyvinylidene fluoride (PVDF) without adding the water-repellent additive, it may be appreciated that when the reagent having surface energy corresponding to ⅓ of that of water (H₂O) is dropped, the membrane does not have hydrophobic properties (please see FIG. 4B).

Whether or not the membrane has hydrophobic properties may be determined according to a contact angle in the case of adding the reagent or water (H₂O).

That is, according to the embodiment of the present invention, a contact angle of the surface of the base layer 1 having the nano-fiber structure may be 120° or more.

Since the contact angle of the surface of the base layer 1 having the nano-fiber structure may be 120° or more as described above, the membrane may have hydrophobic properties, even with respect to the liquid having relatively low surface energy.

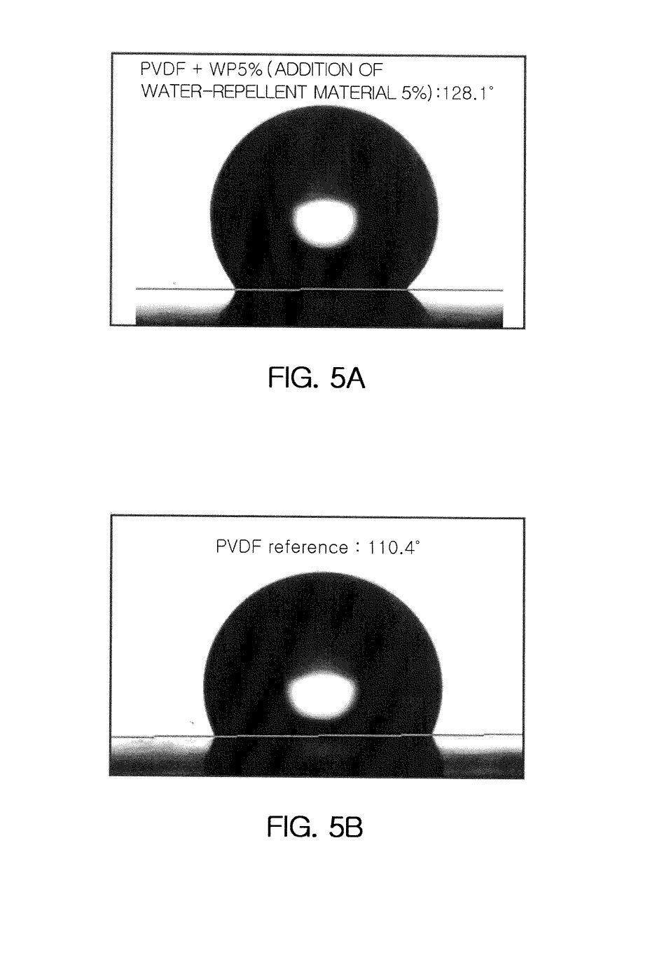

FIGS. 5A and 5B are photographs comparing contact angles of membranes in the case of addition of a water-repellent additive and in the case of non-addition of the water-repellent additive, respectively.

Referring to FIGS. 5A and 5B, it may be appreciated that a contact angle of the membrane is 128.1° in the case of adding a water-repellent additive as in the embodiment of the present invention (See FIG. 5A), and a contact angle of the membrane is 110.4° in the case of not adding the water-repellent additive (See FIG. 5B).

That is, the super hydrophobic membrane according to the embodiment of the present invention may have hydrophobic properties, even with respect to the liquid having low surface energy.

Meanwhile, a method of manufacturing a super hydrophobic membrane according to another embodiment of the present invention may include preparing a mixture solution by adding a water-repellent additive containing fluorine to a polymer solution obtained by dissolving a base polymer in a solvent; and forming a base layer having a nano-fiber structure by spinning the mixture solution by an electro-spinning method.

Hereinafter, the method of manufacturing a super hydrophobic membrane will be described, but descriptions of portions overlapped with those of the super hydrophobic membrane described above will be omitted.

In the method of manufacturing a super hydrophobic membrane, firstly, the mixture solution may be prepared by adding the water-repellent additive containing fluorine to the polymer solution obtained by dissolving the base polymer in the solvent.

The base polymer and the water-repellent additive containing fluorine are the same as those as described above.

Next, a base layer having the nano-fiber structure may be formed by spinning the mixture solution by the electro-spinning method.

The electro-spinning method is a method of instantly spinning low-viscous polymers in a fiber form by using electrostatic force.

The electro-spinning method has an important feature in that nanometer scale fibers may be manufactured using a material having a micro-diameter.

When the electro-spinning method is used, micro-fibers may be produced, and when the micro-fibers are collected, a web may be obtained therefrom.

In a method of manufacturing a super hydrophobic membrane according to another embodiment of the present invention, a general electro-spinning method may be used except for using the mixture solution prepared by adding the water-repellent additive containing fluorine to the polymer solution obtained by dissolving the base polymer in the solvent, but is not limited thereto.

A method of manufacturing a super hydrophobic membrane according to another embodiment of the present invention may further include performing a hydrophilic treatment on the surface of the base layer having the nano-fiber structure, wherein the hydrophilic treatment may be performed by a plasma method or a coating method.

In addition, the method of manufacturing a super hydrophobic membrane may further include forming a hydrophilic material layer containing a hydrophilic material on the surface of the base layer having the nano-fiber structure by the electro-spinning method.

The hydrophilic material layer may only be formed on one surface of the base layer having the nano-fiber structure or may be formed on both surfaces thereof. In the case in which the hydrophilic material layer is formed on both surfaces, the membrane may have a multi-layer structure in which hydrophilic-hydrophobic-hydrophilic layers are sequentially multilayered, such that adhesive properties with regard to different materials may be further improved.

As set forth above, according to the embodiments of the present invention, a super hydrophobic membrane capable of having water-repellency even with respect to liquid such as a surfactant, having relatively low surface energy, may be implemented.

In addition, in the super hydrophobic membrane according to an embodiment of the present invention, hydrophilic treatment may be performed on a surface thereof, or a hydrophilic material layer may be further contained, such that adhesive properties with regard to different materials may be improved.

While the present invention has been shown and described in connection with the embodiments, it will be apparent to those skilled in the art that modifications and variations can be made without departing from the spirit and scope of the invention as defined by the appended claims.

What is claimed is:

1. A super hydrophobic membrane comprising:
a base layer containing a base polymer and a water-repellent additive containing fluorine, and having a nano-fiber structure.

2. The super hydrophobic membrane of claim 1, wherein the base polymer is hydrophobic.

3. The super hydrophobic membrane of claim 1, wherein the base polymer is hydrophilic.

4. The super hydrophobic membrane of claim 1, wherein the base polymer is polyvinylidene fluoride (PVDF).

5. The super hydrophobic membrane of claim 1, wherein the water-repellent additive is a polymeric material.

6. The super hydrophobic membrane of claim 1, wherein the water-repellent additive is at least one selected from a group consisting of poly(2,2,2-trifluoroethyl 2-fluoroacrylate), poly(1-acetyl-1-fluoroethylene), and poly(2,2,3,3,4,4,5,5-octafluoropentyl 2-fluoroacrylate).

7. The super hydrophobic membrane of claim 1, wherein the water-repellent additive is a urethane-based material.

8. The super hydrophobic membrane of claim 1, wherein the water-repellent additive is a monomer or an oligomer.

9. The super hydrophobic membrane of claim 1, wherein a surface of the base layer having the nano-fiber structure is hydrophilic treated.

10. The super hydrophobic membrane of claim 1, wherein a surface of the base layer having the nano-fiber structure is provided with a hydrophilic material layer containing a hydrophilic material.

11. The super hydrophobic membrane of claim 1, wherein a surface of the base layer having the nano-fiber structure has a contact angle of 120° or more.

12. A method of manufacturing a super hydrophobic membrane comprising:
preparing a mixture solution by adding a water-repellent additive containing fluorine to a polymer solution obtained by dissolving a base polymer in a solvent; and
forming a base layer having a nano-fiber structure by spinning the mixture solution by an electro-spinning method.

13. The method of manufacturing a super hydrophobic membrane of claim 12, wherein the base polymer is hydrophobic.

14. The method of manufacturing a super hydrophobic membrane of claim 12, wherein the base polymer is hydrophilic.

15. The method of manufacturing a super hydrophobic membrane of claim 12, wherein the base polymer is polyvinylidene fluoride (PVDF).

16. The method of manufacturing a super hydrophobic membrane of claim 12, wherein the water-repellent additive is a polymeric material.

17. The method of manufacturing a super hydrophobic membrane of claim 12, wherein the water-repellent additive is at least one selected from a group consisting of poly(2,2,2-trifluoroethyl 2-fluoroacrylate), poly(1-acetyl-1-fluoroethylene), and poly(2,2,3,3,4,4,5,5-octafluoropentyl 2-fluoroacrylate).

18. The method of manufacturing a super hydrophobic membrane of claim 12, wherein the water-repellent additive is a urethane-based material.

19. The method of manufacturing a super hydrophobic membrane of claim 12, wherein the water-repellent additive is a monomer or an oligomer.

20. The method of manufacturing a super hydrophobic membrane of claim 12, further comprising performing a hydrophilic treatment on a surface of the base layer having the nano-fiber structure.

21. The method of manufacturing a super hydrophobic membrane of claim 20, wherein the hydrophilic treatment is performed by a plasma method or a coating method.

22. The method of manufacturing a super hydrophobic membrane of claim 12, further comprising forming a hydrophilic material layer containing a hydrophilic material on a surface of the base layer having the nano-fiber structure by the electro-spinning method.

23. The method of manufacturing a super hydrophobic membrane of claim 12, wherein a surface of the base layer having the nano-fiber structure has a contact angle of 120° or more.
